(19) United States
(12) Patent Application Publication
(10) Pub. No.: US 2011/0066762 A1
(43) Pub. Date: Mar. 17, 2011

(54) ELECTRONIC DEVICE FOR SHORTENING INPUT RESPONSE TIME AND METHOD THEREOF

(75) Inventors: MING-TESUNG CHENG, Tu-Cheng (TW); JIE HU, Shenzhen City (CN)

(73) Assignees: HONG FU JIN PRECISION INDUSTRY (ShenZhen) CO., LTD, Shenzhen City (TW); HON HAI PRECISION INDUSTRY CO., LTD., Tu-Cheng (TW)

(21) Appl. No.: 12/581,886

(22) Filed: Oct. 20, 2009

(30) Foreign Application Priority Data
Sep. 14, 2009 (CN) 200910306976.0

(51) Int. Cl. G06F 3/00

(52) U.S. Cl. 710/9

(57) ABSTRACT

An electronic device for shortening input response time comprises an input unit, which comprises a plurality of sub-input units, each of which is assigned a sign. A storage unit is configured for storing a dynamic table, which stores relationships between the sign of the sub-input units and use frequency of each of the sub-input units. A sub-input unit determination module is configured for scanning each of the sub-input units of the electronic device according to the order of the sub-input unit in the dynamic table to determine the touched sub-input unit. An accumulation module is configured for accumulating the use frequency of the determined sub-input unit. An update module is configured for re-sorting the sign of the sub-input unit in the dynamic table according to the order of the use frequency of the sub-input units.

### BACKGROUND

1. Technical Field

The present disclosure relates to an electronic device for shortening input response time and a method thereof.

2. Description of Related Art

In general, when contact is made with a touch screen of an electronic device, all contact points on the touch screen are scanned, and the contact point corresponding to the touch operation are then detected. A function corresponding to the active contact point is executed. However, since all contact point must be scanned, response time of the touch operation on the electronic device is extended.

Therefore, what is needed is an electronic device for shortening input response time.

### BRIEF DESCRIPTION OF THE DRAWINGS

FIG. 1 is a block diagram of the hardware infrastructure of an electronic device for shortening input response time in accordance with an exemplary embodiment.

FIG. 2 is a schematic diagram of a plurality of sub-input units and a corresponding dynamic table of the device of FIG. 1.

FIG. 3 is a schematic diagram of one sub-input unit of FIG. 2 in operation.

FIG. 4 is a block diagram of the hardware infrastructure of the electronic device of FIG. 1, including a detection module, in accordance with another exemplary embodiment.

FIG. 5 is a flowchart of an exemplary embodiment of a method used by an electronic device, such as that of FIG. 1 or FIG. 2.

### DETAILED DESCRIPTION

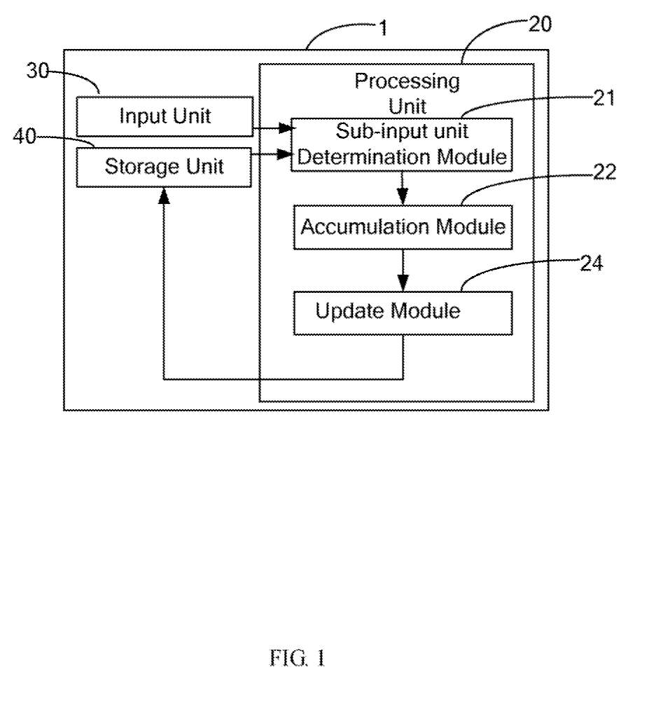

FIG. 1 is a block diagram of the hardware infrastructure of an electronic device for shortening input response time in accordance with an exemplary embodiment, including a processing unit 20, an input unit 30, and a storage unit 40. The input unit 30 is configured for receiving user input, and includes a plurality of sub-input units, each of which corresponds to a function and is assigned a sign. In the exemplary embodiment, the input unit 30 may be a touch screen or keyboard, or other input devices.

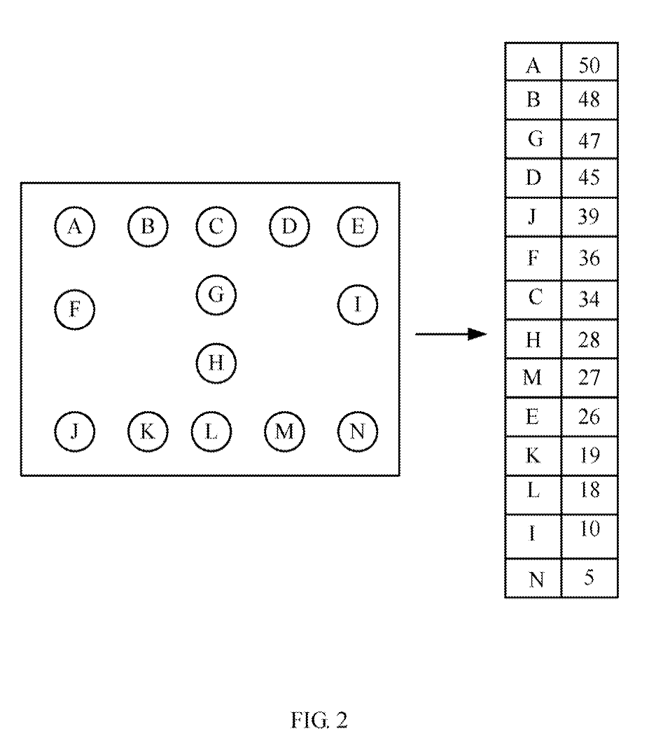

The storage unit 40 is configured for storing a dynamic table. The dynamic table stores relationships between the signs of the sub-input units and use frequencies thereof. In the dynamic table, all signs of the sub-input units are stored according to a descending order of use frequency. As shown in FIG. 2, the input unit 30 includes fourteen sub-input units, respectively assigned: A, B, C . . . N. The first sub-input unit is sub-input unit A, with use frequency of 50. The second sub-input unit is sub-input unit B, with use frequency of 48. The third sub-input unit is sub-input unit G, with use frequency of 47, and so on. The last sub-input unit is sub-input unit N, with use frequency of 5.

The processing unit 20 includes a sub-input unit determination module 21, an accumulation module 22, and an update module 24.

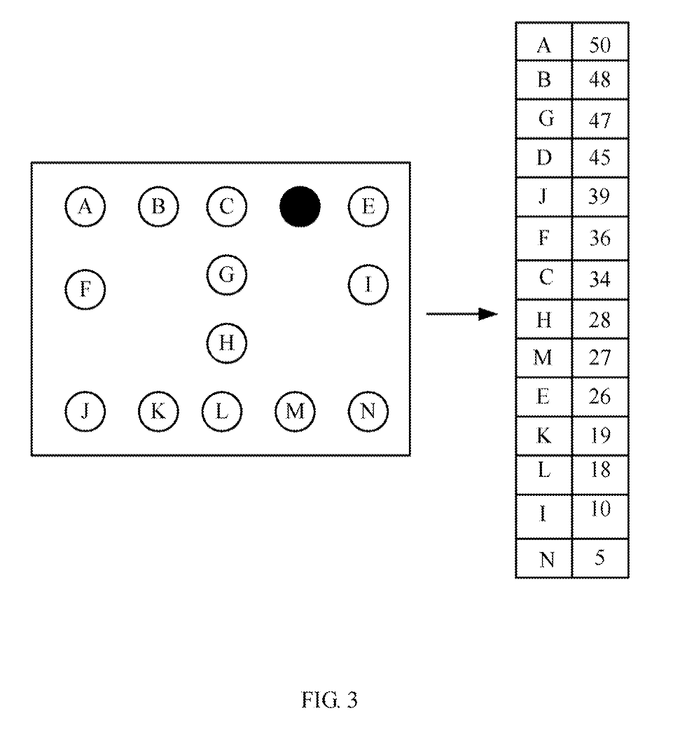

The sub-input unit determination module 21 is configured for scanning each of the sub-input units of the electronic device 1 according to the descending order of the use frequencies stored in the dynamic table to determine which sub-input unit is touched when the input unit 30 receives the contact notification. As shown in FIG. 3, when the input unit 30 receives the contact notification, the sub-input unit determination module 21 scans the sub-input units to determine which sub-input unit is selected, that is, the sub-input unit determination module 21 determines whether the sub-input unit A is selected, and, if no, the sub-input unit determination module 21 continues scanning other sub-input units until the sub-input unit D is determined as the operative sub-input unit.

The accumulation module 22 is configured for accumulating the use frequency of the sub-input unit being selected when the selection of the sub-input unit is determined.

The update module 24 is configured for re-sorting all signs of the sub-input units according to the use frequency when use frequency is accumulated.

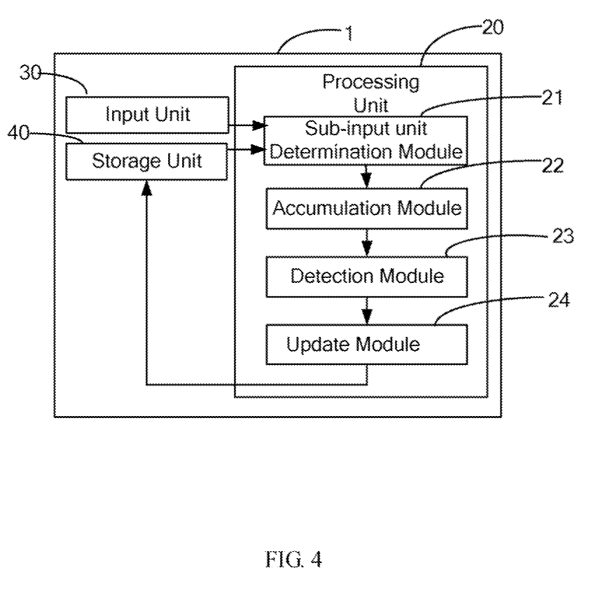

As shown in FIG. 4, in another embodiment, the electronic device 1 further includes a detection module 23. The detection module 23 is configured for detecting operation time of the selected sub-input unit, when more than one sub-input unit, including the selected sub-input unit, has the same use frequency, and the update module 24 re-sorts the sub-input units according the detected operation time among the sub-input units with the same use frequency.

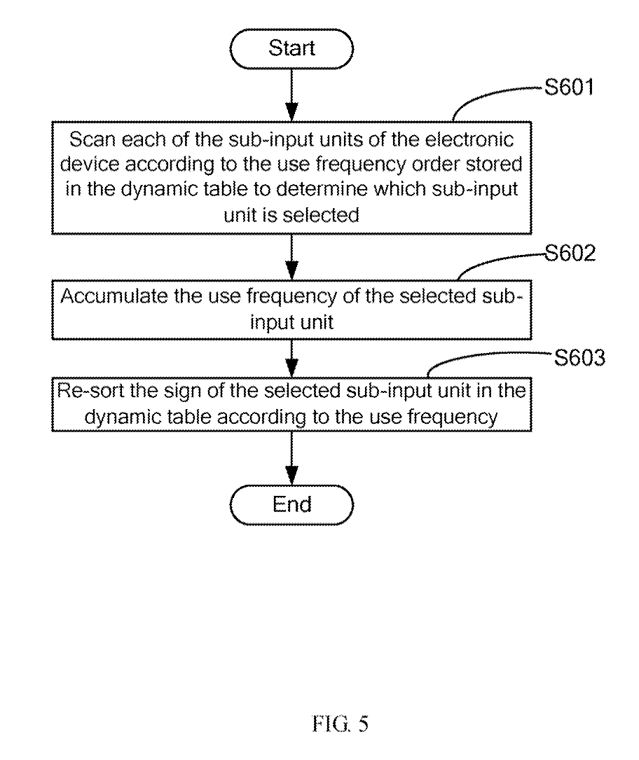

FIG. 5 is a flowchart of a method used by an electronic device as described in the preceding disclosure.

In step S601, the sub-input unit determination module 21 scans each of the sub-input units of the electronic device 1 according to the use frequency order stored in the dynamic table to determine which sub-input unit is selected when the input unit 30 receives the contact notification.

In step S602, the accumulation module 22 accumulates the use frequency of the selected sub-input unit when the selected sub-input unit is determined.

In step S603, the update module 24 re-sorts the sign of the selected sub-input unit in the dynamic table according to the use frequency when the use frequency of the selected sub-input unit is accumulated.

In another embodiment, the method further includes, when the use frequencies of the sub-input units are the same, the detection module 23 detecting the operation time of the sub-input units when the sub-input unit is touched newly. The updating module 24 re-sorts the sub-input units according to the detected operation time among the sub-input units with equal use frequencies.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic device for shortening input response time, comprising:
an input unit comprising a plurality of sub-input units, each of which is assigned a sign;
a storage unit configured for storing a dynamic table storing relationships between each sign and the use frequency of the sub-input unit corresponding to the sign in a predetermined order;
a sub-input unit determination module configured for scanning each of the sub-input units of the electronic device according to the predetermined order of the use frequencies of the sub-input units in the dynamic table to determine which sub-input unit is selected when the input unit receives a contact notification;
an accumulation module configured for accumulating the use frequencies of the selected sub-input unit when the selected sub-input unit is determined; and
an update module configured for re-sorting the sign of the selected sub-input unit in the dynamic table according to the use frequencies when the use frequencies of the operative sub-input unit are accumulated.

2. The electronic device for shortening input response time as claim 1, further comprising a detection module configured for detecting operation time of the selected sub-input unit, when more than one sub-input unit, including the selected sub-input unit, has the same use frequency, and the update module re-sorts the sub-input units according the detected operation time among the sub-input units with the same use frequency.

3. The electronic device for shortening input response time as claim 1, wherein the predetermined order is a descending order.

4. The electronic device for shortening input response time as claim 1, wherein the input unit is a touch screen.

5. The electronic device for shortening input response time as claim 1, wherein the input unit is a keyboard.

6. A method for shortening input response time implemented by an electronic device comprising an input unit and a storage unit; wherein the input unit comprises a plurality of sub-input units, each assigned a sign, and the storage unit stores relationships between the signs and use frequencies of each of the sub-input units corresponding to the signs in a predetermined order, the method comprising:
scanning each of the sub-input units of the electronic device according to the predetermined order to determine which sub-input unit is selected when the input unit receives a contact notification;
accumulating the use frequencies of the selected sub-input unit when the selected sub-input unit is determined; and
re-sorting the sign of the selected sub-input unit in the dynamic table according to the use frequency, when the use frequencies of the operative sub-input unit is accumulated.

7. The method for shortening input response time as claim 6, further comprising:
detecting operation time of the selected sub-input unit when more than one sub-input unit, including the selected sub-input unit, has the same use frequency; and
re-sorting the sub-input units according the detected operation time among the sub-input units with the same use frequency.

8. The method for shortening input response time as claim 6, wherein the predetermined order is a descending order.
